(19) United States
(12) Patent Application Publication
(10) Pub. No.: US 2019/0197547 A1
(43) Pub. Date: Jun. 27, 2019

(54) Systems and Methods for Modifying Exposure Associated With Networks Based on One or More Events

(71) Applicant: MASTERCARD INTERNATIONAL INCORPORATED, Purchase, NY (US)

(72) Inventors: Ravi Garg, O'Fallon, MO (US); Stephen David Strohm, Dardenne Prairie, MO (US)

(21) Appl. No.: 15/850,839

(22) Filed: Dec. 21, 2017

(51) Int. Cl. G06Q 20/40

(52) U.S. Cl. CPC G06Q 20/4016

(57) ABSTRACT

Systems and methods are provided for use in modifying exposure associated with networks based on one or more events. One exemplary method includes obtaining, by a computing device, content from multiple data sources where the content includes at least one event associated with a region and where the at least one event is not associated with a payment account transaction, and assigning, by the computing device, the at least one event to a category of events based on a type of the at least one event. The method then also includes applying at least one rule to at least one operation of a payment network, for the region, based on a severity associated with exposure of the at least one event to the payment network, thereby modifying the exposure of the payment network in the region in connection with payment account transactions related to the at least one rule.

### FIELD

The present disclosure generally relates to systems and methods for use in modifying and/or adopting exposure associated with networks based on one or more events and, in particular, to systems and methods for modifying exposure associated with networks based on actions applied in response to severity of the one or more events.

### BACKGROUND

This section provides background information related to the present disclosure which is not necessarily prior art.

Payment account transactions are employed ubiquitously in commerce, whereby consumers purchase products (e.g., goods and/or services) from merchants through use of payment accounts. In connection with authorizing such transactions, issuers associated with payment accounts involved in the transactions, or payment networks involved in processing the transactions, may rely on certain metrics and/or models to predict issues with the transactions such as, for example, fraud. In this manner, the issuers and/or payment networks attempt to identify fraudulent transactions prior to authorization, so that the transactions may be declined. The fraud prevention metrics and/or models are based on data specific to the payment account transactions, for example, transaction locations, card present indicators, transaction amounts, merchant identifiers, merchant category codes (MCCs), etc.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in modifying exposure associated with networks based on one or more events;

FIG. 2 is a block diagram of a computing device that may be used in the exemplary system of FIG. 1; and

FIG. 3 is an exemplary method that may be implemented in connection with the system of FIG. 1 for modifying exposure associated with networks based on one or more events.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Payment account transactions often involve transactions in which merchants are located in various different regions. The transactions to the merchants in the different regions fluctuate at different times, for different reasons. In addition, as the type and velocity of transactions fluctuate over time, the existence of fraudulent transactions may fluctuate over time.

Uniquely, the systems and methods herein provide a correlation between events in a region and changes in transaction data before, during or after the events, thereby permitting modification of exposure associated with networks involved in transactions in the region based on one or more events (e.g., payment networks, issuers, etc.). In particular, an exposure engine is provided to obtain content from different sources (e.g., news sources, social media networks, etc.) for different regions, and identify one or more events therein (i.e., control events). The exposure engine further identifies particular events of interest from the obtained content, for example, based on keyword searching, category searching, etc. Rules, then, define actions to be taken, based on the particular events, to limit or otherwise modify the exposure of issuers and/or payment networks associated with transactions in the identified regions(s). In this manner, the exposure engine permits the payment networks, issuers, or other entities associated with the transactions to limit exposure to adverse results/impact of the events and/or to encourage desired consumer transaction behaviors (e.g., to inhibit fraudulent transactions, etc.) in association with the events.

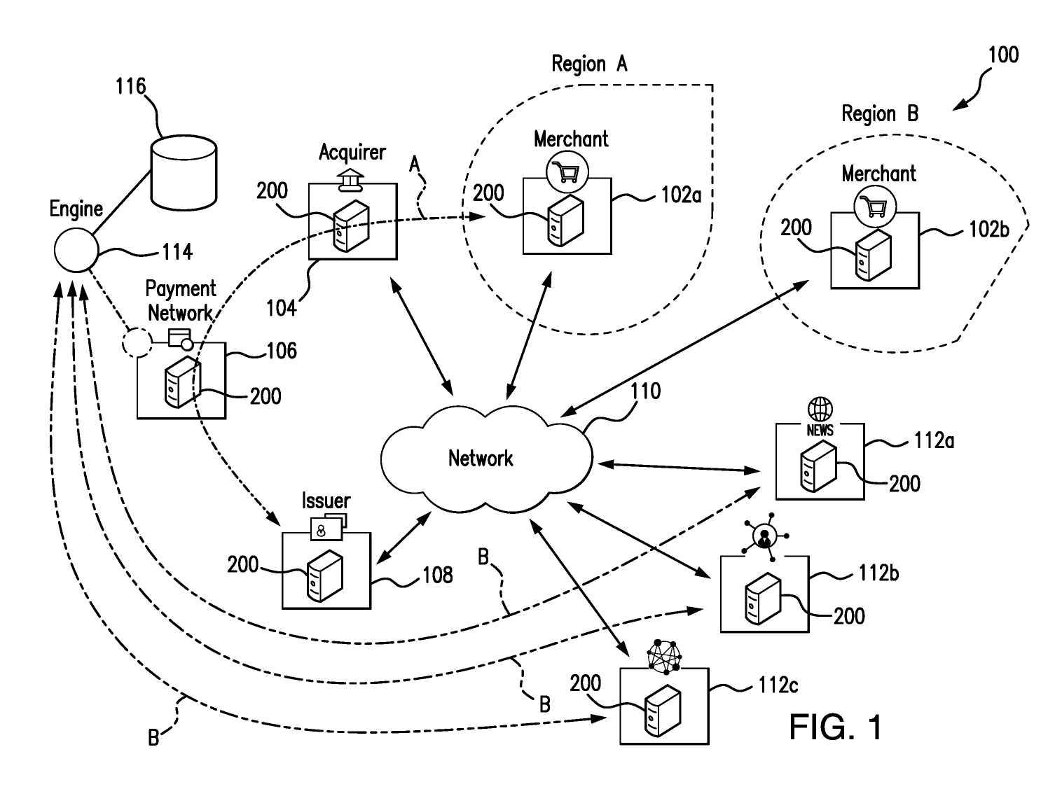

FIG. 1 illustrates an exemplary system 100 in which one or more aspects of the present disclosure may be implemented. Although the system 100 is presented in one arrangement, other embodiments may include the parts of the system 100 (or other parts) arranged otherwise depending on, for example, alternative regional groupings in the system 100, differing transactional roles between parts of the system 100, additional parties to transactions in the system 100, etc.

The system 100 generally includes merchants 102a-b, an acquirer 104 generally associated with the merchants 102a-b, a payment network 106, and an issuer 108 configured to issue payment accounts to consumers, each of which is coupled to (and is in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which may provide interconnection between the merchants 102a-b and the acquirer 104 (as appropriate), etc.

The merchants 102a-b may each include any type of merchant, which offers products (e.g., goods, services, etc.) for sale to consumers and/or sells products to consumers. The products may be any different type and/or category of products, etc., in the embodiments herein. Further, as shown in FIG. 1, the merchant 102a is located in region A, while the merchant 102b is located in region B. The different regions A and B may be defined, without limitation, as different cities, counties, states, countries, territories, postal codes, etc. In addition, the regions A-B may overlap at least partially in some embodiments. However, the regions A-B will generally be exclusive to one another. What's more, while only the merchants 102a-b are illustrated as located within the particular regions A-B, respectively, any of the acquirer 104, the payment network 106, the issuer 108 and/or the network 110 may be located in, or at least partially in, the region A and/or the region B in various system embodiments.

Also in the system 100, various consumers (not shown) are associated with payment accounts issued by the issuer 108 and/or by other issuers (not shown). The payment accounts are used, by the consumers, to fund purchase transactions for products at the merchants 102a-b, which in turn are generally processed via the acquirer 104, the payment network 106, and the issuer 108 (and/or other issuers).

As an example transaction, a consumer may desire to purchase one or more products from the merchant 102a, for example, via a payment device associated with his/her payment account. In so doing, the consumer presents the payment device to the merchant 102a, for example, to a point-of-sale (POS) device (not shown) associated with the merchant 102a. In response, the merchant 102a is configured, by executable instructions at the POS device, to compile and transmit an authorization request to the acquirer 104 (along path A) for the transaction. While presented with reference to merchant 102a, transactions involving merchant 102b (and one or more other consumers), in region B, for example, will be substantially consistent with the example transaction described and involving merchant 102a.

In turn in this example transaction, the acquirer 104 communicates the authorization request through the payment network 106 (e.g., through MasterCard®, VISA®, Discover®, American Express®, etc.) to the issuer 108. In response to the authorization request, the issuer 108 determines whether the transaction should be approved, for example, based on whether the payment account associated with the consumer is in good standing and includes sufficient funds and/or credit to cover the transaction. After approving or declining the transaction, the issuer transmits an authorization reply back, along path A, to merchant 102a, which permits the merchant 102a to complete the transactions, or, potentially, when declined, request alternative payment. Thereafter, the transaction is cleared and settled by and between the involved parts of system 100 (consistent with agreements between the acquirer 104, the payment network 106, the issuer 108, etc.).

Transaction data is generated, collected, and stored in the above-described example transaction (and in other transactions in the system 100) as part of the interactions among the merchant 102a (and the merchant 102b when involved), the acquirer 104, the payment network 106, the issuer 108, and the consumer. The transaction data includes a plurality of transaction records, one for each transaction, or attempted transaction in the system 100. The transaction records, in this exemplary embodiment, are stored at least by the payment network 106 (in a data structure 116, for example, associated with the payment network 106, etc.) (e.g., as authorization messages (including authorization requests and authorization replies, etc.), clearing messages/files, or settlement records, etc.). The transaction data may be stored with personal identifying information (PII), or without PII. As generally described above, the transaction records may include, for example, payment account numbers or other IDs, amounts of transactions, merchant names, merchant IDs, merchant locations, transaction types, transaction channels, dates/times of the transactions, currency codes, country codes, merchant category codes (MCCs), processing codes or other suitable dimensions of a transaction, as described below, or otherwise, etc. (broadly, transaction data). It should be appreciated that more or less information related to transactions, as part of either authorization or clearing and/or settling, may be included in transaction records and stored within the system 100 at the payment network 106, and/or otherwise at the merchants 102a-b, the acquirer 104, and/or the issuer 108.

With continued reference to FIG. 1, the system 100 also includes three content sources 112a-c, each configured to provide content as described herein. The content generally relates to one or more different events including, for example, news events, natural events, political events, etc. For example, a natural event may include a natural calamity such as a flood, a drought, a tsunami, a volcanic eruption, a hurricane, a plague, an epidemic/pandemic, a tornado, an earthquake, etc., while a political event may include an election, a scandal, an appointment, an investigation, a firing, etc. In general, the events include events occurring apart from the payment network 106, and which may alter and/or affect transactions and/or intentions associated with consumers initiating payment account transactions as processed by the payment network 106. That is, for example, a natural calamity may cause an uptick in fraudulent transactions by fraudsters posing as persons affected by the natural calamity and/or preying on those persons actually affected by the natural calamity.

One or more of the content sources 112a-c may include a specific news source such as, for example, CNN, Fox News, MSNBC, etc., or one or more of the content sources 112a-c may include a news aggregator such as, for example, Watson Alchemy by IBM™, www.newsAPI.com (which returns JSON metadata for the headlines currently published on a range of news sources), www.news.aylien.com (which provides Search and source functions for news and content from around the web in real-time), etc. In addition, one or more of the content sources 112a-c may include a social network such as, for example, Twitter™, Instagram™ Facebook™, Pinterest™, or other social network, etc., through which persons may post content related to events. In general, it should be understood that the content of the content sources 112a-c may be readily altered, whereby it is expected that each of the content sources 112a-c will include content related to an event, in a region, when the event is of sufficient note or importance. In this exemplary embodiment, the content sources 112a-c include application programming interfaces, or APIs, which permit access to the content provided by and/or included in the respective sources 112a-c. In connection therewith (and in the discussion below), the content sources 112a-c include, respectively, a news source 112a, a social network 112b, and a news aggregator 112c. With that said, other/different content sources and/or a different number of content sources may be included in the system 100 in other embodiments.

It should be appreciated that while only two merchants 102a-b in two regions A-B, one acquirer 104, one payment network 106, one issuer 108, and three content sources 112a-c are illustrated in the system 100 in FIG. 1 (for ease of description), the system 100 and/or other system embodiments will generally include multiple of each of these parts, with interactions as described above by and between the parts.

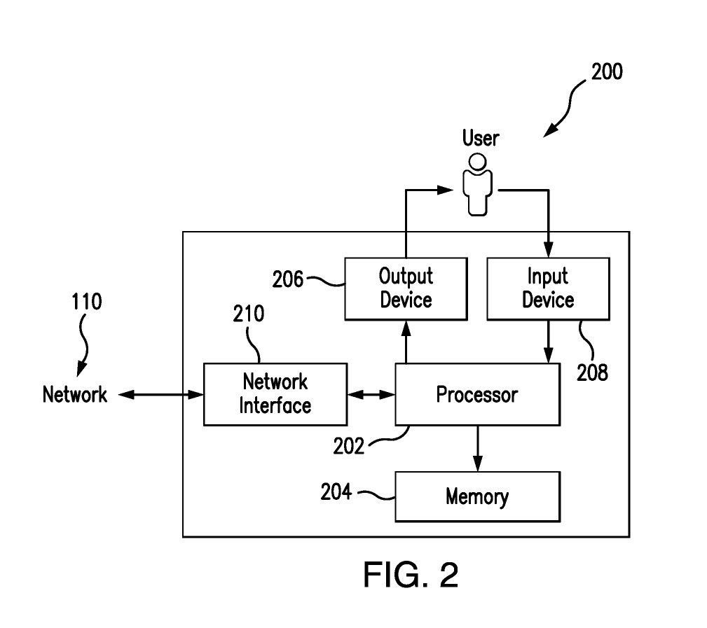

FIG. 2 illustrates an exemplary computing device 200 that can be used in the system 100. The computing device 200 may include, for example, one or more servers, workstations, personal computers, laptops, tablets, smartphones, PDAs, POS devices, etc. In addition, the computing device 200 may include a single computing device, or it may include multiple computing devices located in close proximity or distributed over a geographic region, so long as the computing devices are specifically configured to function as described herein. In the exemplary system 100 of FIG. 1, each of the merchants 102a-b, the acquirer 104, the payment network 106, the issuer 108, and the content sources 112a-c are illustrated as including, or being implemented in, computing device 200 coupled to (and in communication with) the network 110. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured, as one or more data structures, to store, without limitation, transaction data, rules, severity maps, actions, thresholds, events, and/or other types of data (and/or data structures) suitable for use as described herein. Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer-readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 includes an output device 206 that is coupled to (and is in communication with) the processor 202. The output device 206 outputs information (e.g., defined actions, etc.), visually, for example, to a user of the computing device 200 (e.g., a consumer, a user associated with the payment network 106, etc.). It should be further appreciated that various interfaces (e.g., as defined by network-based applications, websites, etc.) may be displayed at computing device 200, and in particular at output device 206, to display certain information to the user. With that said, the output device 206 may include, without limitation, a liquid crystal display (LCD), a light-emitting diode (LED) display, an organic LED (OLED) display, an “electronic ink” display, speakers, other devices configured to output data, etc. In some embodiments, the output device 206 may include multiple devices.

The computing device 200 also includes an input device 208 that receives inputs from the user (i.e., user inputs) such as, for example, selections of certain defined actions, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, etc. Further, in various exemplary embodiments, a touch screen, such as that included in a tablet, a smartphone, or similar device, may behave as both the output device 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 may include the processor 202 and one or more network interfaces incorporated into or with the processor 202.

Referring again to FIG. 1, the system 100 includes an exposure engine 114 specifically configured, by executable instructions, to operate as described herein. The exposure engine 114 is illustrated as a standalone part of the system 100 and, in this manner, may be considered as one or more specific computing devices consistent with computing device 200. Additionally, or alternatively, the exposure engine 114, as indicated by the dotted line in FIG. 1, may be integrated, in whole or in part, with the payment network 106 (e.g., as part of the computing device 200 associated therewith, etc.). In addition, the exposure engine 114 is coupled to the data structure 116, which may be standalone from the exposure engine 114 or integrated in whole, or in part, with the exposure engine 114 (and by extension with the payment network 106, when the exposure engine 114 is integrated therein). When the data structure 116 is standalone from the exposure engine 114, it may also be considered a computing device generally consistent with computing device 200. In other embodiments, the exposure engine 114 may be integrated in whole or in part with the issuer 108 (e.g., as part of the computing device 200 associated therewith, etc.) or other part of the system 100.

Initially, the exposure engine 114 is configured to identify a current or recent event (or multiple events) from one or more of the content sources 112a-c based on various preconfigured (or predefined) events (and/or categories of such events). For example, the exposure engine 114 may retrieve all available content from the content sources 112a-c via corresponding APIs associated with each of the content sources 112a-c (as indicated by path B in FIG. 1 for each of the content sources 112a-c). And then, the exposure engine 114 may be configured to search the retrieved content for one or more of the preconfigured events. Alternatively, the exposure engine 114 may be configured to retrieve particular content from the content sources 112a-c, via the corresponding APIs, based on one or more of the preconfigured events, such that subsequent searching of the retrieved content is not required (e.g., the exposure engine 114 may be configured to only retrieve content that involves and/or relates to one or more of the preconfigured events, etc.). In any case, examples of the preconfigured events (and/or categories) for which the exposure engine 114 may search include, without limitation, earthquakes, political events, sporting events, fraud attacks, weather/storm events, power outages, network connection outages, transportation strikes, union strikes, etc.

Once a current or recent event is identified from one or more of the content sources 112a-c, the exposure engine 114 is configured to determine a severity for the identified event based on the assigned severity for a matching preconfigured event (and/or for a category of the event), for example, in a severity map (stored in data structure 116) associated with the payment network 106 and/or the issuer 108, etc. As will be described, the assigned severity may then be used by the exposure engine 114 to take appropriate actions based on the event, for example, block certain transaction, raise alerts, etc. What's more, it should be appreciated that each action taken by the exposure engine 114 may trigger subsequent rule strategies, which may determine further courses of action. In addition, the exposure engine 114 is configured to associate a positive or negative sentiment with the identified event (e.g., an identified earthquake event may have a negative sentiment associated therewith and an identified sporting event victory may have a positive sentiment associated therewith, etc.) and a location/region associated with the identified event (e.g., based on the retrieved content, etc.). The sentiment may then be used by the exposure engine 114, for example, to determine if positive or negative actions should be taken in connection with and/or in response to the event. With that said, positive actions may include increasing certain thresholds for transactions, while negative actions may include decreasing such thresholds or blocking transactions, etc.

Then in the system 100, and as generally discussed above, based on the severity of the identified event (e.g., where the event is pre-configured to a given severity, etc.), the sentiment, and the location/region of the identified event, the exposure engine 114 is configured to assign a responsive action (or rule) to the event, based on the matching preconfigured event (and/or category of event) in the severity map. And, in turn, the exposure engine 114 is configured to implement the assigned responsive action (e.g., via the payment network 106, etc.). For example, the exposure engine 114 may be configured to identify issuers (e.g., the issuer 108, etc.) located in (or having a presence in) the location/region affected by the identified event, and then apply the assigned action to at least one operation of the payment network 106 and/or the issuer 108, for example, in connection with payment account transactions taking place in the region(s) in which the identified event occurred. As a result, the exposure engine 114 thereby modifies an exposure of the payment network 106 and/or the issuer 108, for example, associated with the corresponding payment account transactions.

Table 1 illustrates an example severity map for the payment network 106 comprising multiple exemplary preconfigured events, and that may be used by the exposure engine 114 to identified severity and responsive actions (or rules) for an identified event from the content sources 112a-c. As shown, each of the preconfigured events is associated with a category (e.g., terrorism, bank/merchant failure, financial fraud, political unrest, natural calamity, sporting event, etc.). Each of the preconfigured events is also associated with a severity or criticality (e.g., a severity of 1 for a high risk, a severity of 2 for a moderate risk, a severity of 3 for a low risk, and a severity of 4 for a positive event; etc.), and an action to be taken in response to the event.

TABLE 1

| Event | Category | Severity | Action |
|---|---|---|---|
| Terrorist | Terrorism | 1 | Lower ATM withdrawal limits |
| attack | | | |
| Personal | Bank/ | 2 | Notify customer |
| information | Merchant | | representative/internal |
| breach at | Failure | | representative |
| merchant | | | |
| A | | | |
| Bank filing | Financial | 2 | Notify internal representative |
| bankruptcy | Fraud | | |
| Scandal | Political | 2 | Notify internal representative, |
| involving | Unrest | | Lower transaction limits for |
| elected | | | affected country |
| official | | | |
| Earthquake | Natural | 1 | Lower fraud score threshold for |
| | Calamity | | transactions involving MCC 5200 |
| | | | (home supply warehouse stores) |
| Index drops | Financial | 3 | Monitor for transactions originating |
| more than | Event | | from that country region, notify |
| 3% | | | internal representatives |
| Tornado | Natural | 2 | Lower fraud score thresholds to |
| | Calamity | | allow more transactions |
| World Cup | Sporting | 4 | Increase thresholds for transactions |
| victory | Event | | from merchant type restaurant/bar/ |
| | | | merchandise |

In connection therewith, the severity of each of the preconfigured events in the severity map of Table 1 may be determined (e.g., by the exposure engine 114, or by another entity, etc.) through use of historical transaction data and, based thereon, identification of shifts in types, numbers, etc. of transactions initiated during and after a historical event corresponding to each of the given preconfigured events. For example, the exposure engine 114 may be configured to initially access (and potentially retrieve) transaction data associated with the desired historical event, from the data structure 116 (e.g., for a time frame associated with the historical event including a control interval and an effect interval, etc.). The transaction data includes authorization, clearing and/or settlement data representative of multiple transactions in the regions A-B, and potentially other regions, associated with the historical event. The transaction data accessed by the exposure engine 114 may be specific to certain regions (e.g., the regions A-B, etc.), or not, and may be aggregate data, or not.

In particular, the exposure engine 114 may be configured to access transaction data for a control interval and an effect interval associated with the historical event. The control interval generally includes an interval prior to the historical event, either directly preceding the event or based on a similar interval, season, etc., in a prior year, etc. That is, the control interval may include, for example, the last thirty days prior to the historical event, or thirty days prior to the historical event from the prior year (or, of course, some other interval). The effect interval, then, will generally include an interval that is the same as, or similar to, the control interval but that includes the historical event itself. Or, the effect interval may commence just after the historical event, whereby, in either instance (regardless of whether the effect interval includes the historical event or not), the effect interval at least partially follows the control interval. Both intervals may be hours, days, weeks, months, etc., or longer, or shorter.

Then, the exposure engine 114 may be configured to determine the severity of the historical event, by comparing the accessed transaction data from the control interval to the accessed transaction data from the effect interval. The change, if any, between fraudulent transactions, transaction amounts, transaction velocities, transacting merchants, etc. in the two intervals is determined, and then the exposure engine 114 is configured to compare the determined change to a threshold (or range of thresholds) to determine the severity of the event.

It should be understood that the severity value ultimately included in the severity map of Table 1 may include the severity determined, by the exposure engine 114, for the historical event (as discussed above), or it may include a combination (e.g., an average, a weighted average, a sum, etc.) of severities determined for multiple of the same types of historical events, or it may include a severity for the overall category of the event (which may include multiple different types of historical events grouped into the same category). When the severity is determined for the category of the event, transaction data for a series of events in the given category may be obtained and compared, as above, to determine severities for each of the events, which are then combined (e.g., by average, sum, etc.) before being compared to a threshold (or otherwise) to determine overall severity for the category of the event(s).

Similarly, the actions associated with the preconfigured events in the severity map of Table 1 may be determined (e.g., by the exposure engine 114, or by another entity, etc.) through use of historical transaction data and, based thereon, identification of shifts in types, numbers, etc. of transactions initiated during and after a historical event corresponding to each of the given preconfigured events.

Thereafter, the exposure engine 114 may be configured to compile the severity map of Table 1, which includes multiple events and multiple categories of events.

It should be appreciated that the particular categories included in the severity map of Table 1 may be defined, or set, by the payment network 106 (with similar categories being defined by the issuer 108 for a severity amp associated with the issuer 108). It should also be appreciated that the severity map may include more, less, and/or different categories and/or preconfigured events in other embodiments. What's more, the issuer 108 may define different categories and/or preconfigured events for its severity map (or the issuer 108 may simply use the same severity map of Table 1 as provided by the payment network 106). Further, a specificity of the categories and/or preconfigured events defined by the payment network 106, the issuer 108, etc. in the severity map may be different depending on a number of factors. Specifically, for example, as described below, an action may be defined per category, whereby the payment network 106 and/or the issuer 108 may define the categories with sufficient specificity so that the action may be applied for all events within the category, etc. Or, different events within the same category may include different actions.

As an example application of the above, when the exposure engine 114 identifies a recent earthquake in southern California (in the United States) (e.g., region A) from the news source 112a, it may be configured to compare the earthquake event to the preconfigured events in Table 1. In so doing, the exposure engine 114 identifies it as a natural calamity with a severity of 1 (i.e., a high risk). The exposure engine 114 also associates a negative sentiment with the earthquake and identifies the country/region of the earthquake as United States/southern California. Then, the exposure engine 114 may be configured to assign a particular responsive action to the identified earthquake event such as, for example, lowering a fraudulent activity threshold limit for transactions involving MCC 5200, and apply the action to all of the specified transactions involving the payment network 106 and taking place in southern California (based on merchant data included in transaction data for the transactions) (e.g., transactions at the merchant 102a, etc.). In addition, in various aspects of the present disclosure, the issuer 108 may also implement the identified action (for example, upon notification by the payment network 106, at its own initiative based on notification by the exposure engine 114, etc.).

As another example application, when the exposure engine 114 identifies that the United States has recently won a World Cup soccer match against Brazil in Denver, Colo. (in the United States) (e.g., region B), the exposure engine 114 may be configured to compare the World Cup soccer event to the preconfigured events in Table 1. In so doing, the exposure engine 114 identifies it as a sporting event with a severity of 4 (i.e., a positive event). The exposure engine 114 also associates a positive sentiment with the World Cup soccer victory and identifies the country/region of the victory as United States/Denver, Colo. Then, the exposure engine 114 may be configured to assign a particular responsive action to the identified World Cup soccer event such as, for example, increasing a fraudulent activity threshold limit for transactions involving restaurants, bars, and sporting merchandise, and apply the action to all of the specified transactions involving the payment network 106 and taking place in Denver, Colo. (or, potentially, in Colorado in general), based on merchant data included in transaction data for the transactions (e.g., transactions at the merchant 102b, etc.).

While the exposure engine 114 is configured to identify the events herein based on preconfigured event types, in other embodiments the exposure engine 114 may include a learning mode configured to identify events and independently determine severity thereof (e.g., in a similar manner to the above description regarding generation of the severity map whereby the severity of an identified event may be determined in real time based on transaction data specific to the identified region, etc.).

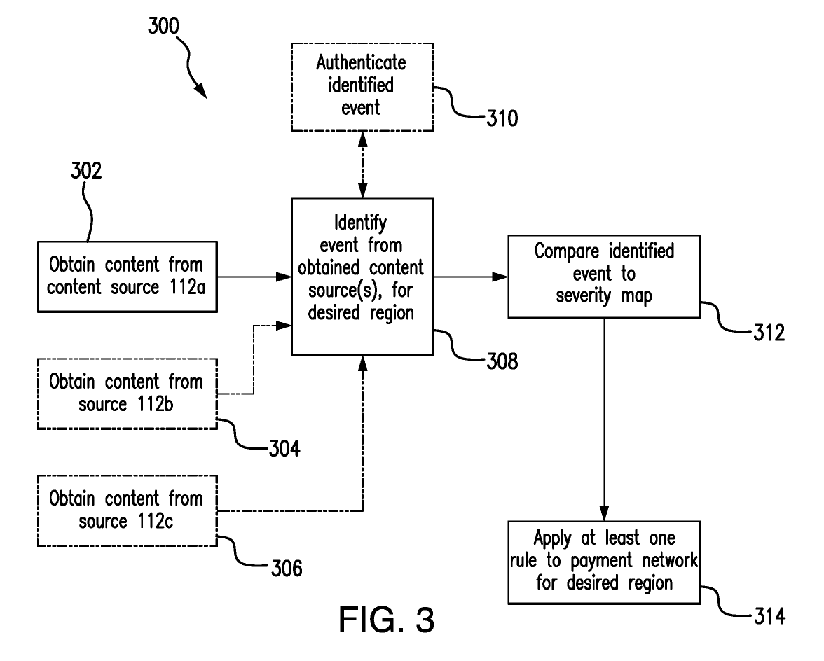

FIG. 3 illustrates an exemplary method 300 for modifying an exposure of a payment network, issuer, etc. in a region based on one or more events, for example, within the region and/or affecting the region. The exemplary method 300 is described as implemented in the exposure engine 114 of the system 100, with additional reference to the other parts thereof. However, the method 300 is not limited to the exposure engine 114, or more generally, to the system 100. Further, the exemplary method 300 is described herein with reference to the computing device 200. But the methods herein should not be understood to be limited to the exemplary computing device 200. Likewise, the systems and computing devices herein should not be understood to be limited to the exemplary method 300.

The method 300 is also described below with reference to two exemplary preconfigured events, including a natural calamity (e.g., an earthquake, etc.) and a terrorist event. Each of the events will occur in region A of the system 100, or has recently occurred in region A. It should be appreciated that, as described above, different events in the same or different regions of the system 100 (or of other system embodiments) may be the subject of the method 300 and/or other method embodiments. That is, the methods contemplated herein are not limited to the multiple exemplary events associated with region A described below.

As shown in FIG. 3, at 302 in the method 300, the exposure engine 114 obtains content from the content source 112a, which in this example includes a news source. From time to time, or at one or more intervals, the exposure engine 114 calls one or more APIs associated with the news source 112a, including, for example, the news API at the websites: www.newsAPI.org, or www.newsapi.aylien.com, etc. For example, the news API (and other APIs associated with the content sources 112a-c) may include an adapter associated with the exposure engine 114, whereby the adapter is configured to search the corresponding website(s) for desired events (e.g., continuously, at desired intervals, hourly, daily, etc.). In connection therewith, the API call then generally includes a request, via the API, for all content available through the news source 112a, for content available through the news source 112a and related to a particular region and/or to specific keywords and/or specific categories of events (e.g., natural calamities and terrorist events in this example), etc. Of course, the news source 112a (and the content sources 112a-c in general) should not be understood to be limited to these specific examples, as other news sources (or other content sources in general), for example, at different addresses, in the same or a different manner (i.e., through an API, or not), may be employed, accessed, or called, etc. in other embodiments.

In addition in the method 300, optionally, as indicated by the dotted lines in FIG. 3, the exposure engine 114 may obtain content from the content source 112b, at 304, and/or content from the content source 112c, at 306 (broadly, obtain content from multiple sources). The content sources 112b-c, as explained above, may include a social network content source and a news aggregator content source, respectively Like with the source 112a, the exposure engine 114 may call an API or multiple APIs associated with the sources 112b-c, or may obtain the desired content by one or more other manners (other than via an API). As an example, an API may be provided from the social network source 112b, whereby the exposure engine 114 (via an adapter) is able to obtain social network content, without PII, from the social network source 112b such that the content is indicative of one or more events but may not be identified to a particular person or to a minimum number of persons.

The exposure engine 114 may further obtain content from the sources 112a-c for only a certain region, such as, for example, region A. In addition, the content may be specific to the region based on a particular one of the sources 112a-c. For example, the source 112b may be limited to region B, while the source 112a may be unlimited such that the exposure engine 114 would not obtain content from the source 112b (but would instead obtain it from source 112a) when interested only in region A. Moreover, the exposure engine 114 may limit the content obtained from the sources 112a-c based on a keyword search (as indicated above) and/or other mechanisms, whereby the exposure engine 114 obtains content related to specific events and/or types of events, to the exclusion of other content. In the method 300 of FIG. 3, for example, when interested in natural calamities in region B, and not financial frauds, the exposure engine 114 may call an API associated with the news aggregator source 112b, with keywords: flood, drought, tsunami, volcanic eruption, hurricane, plague, epidemic/pandemic, tornado, and earthquake. In this manner, the exposure engine 114 obtains content related to these exemplary natural calamities in region B, but not content related to a financial situation affecting the viability of home loans, etc.

Thereafter, the exposure engine 114 identifies, at 308, one or more events of interest from the obtained content. In particular, when content is obtained from the sources 112a-c, the content may include substantial information which may or may not relate to events of interest. As such, the exposure engine 114 identifies the events, i.e., the events of interest, for example, through keyword searching in the obtained content. In at least one embodiment, though, the exposure engine 114 may obtain specific content, for example, through keyword searching, such that the content obtained from the source(s) 112a-c is then specific to the event of interest, whereby a further identification of the event(s) of interest (e.g., at 308, etc.) is not needed. In this manner, the exposure engine 114 obtains desired content from one or more of the sources 112a-c and identifies the event(s) of interest, at 302 and 308, together. In various embodiments, the event of interest is not associated with a payment account transaction.

As an example, the news source 112a may include an API associated with the URL: https://newsapi.org/v1/sources?language=en may include, whereby a general API call by the exposure engine 114 to the news source 112a may return a listing of all available news sources and their corresponding regions/countries. Then, the same API call may again be made to get news/events for each of the particular sources (using source IDs for the identified sources), for example, via the URL: https://newsapi.org/v1/articles?source=abc-news-au&sortBy=latest<API_KEY>, whereby the API then returns corresponding headlines for various articles from the news sources and brief descriptions thereof. In turn, the articles may then be searched to identify desired events. Subsequently, there would be strategies executed to identify issuers (or other banks) operating in the identified region with desired actions then setup for the event(s).

In connection with identifying the event(s) of interest, the exposure engine 114 may, optionally, authenticate the identified event(s) for accuracy, at 310. In particular, the exposure engine 114 may identify an event based on content from the source 112a. And, once identified, the exposure engine 114 may obtain content from the source 112b (e.g., at 304, etc.), which is specific to the identified event (e.g., using keywords, etc.). The exposure engine 114 may then attempt to authenticate the identified event by searching for the event (or identifying the event) in the content from the source 112b. As an example, when an earthquake event is identified (as described above), by the exposure engine 114 from the news source 112a, the exposure engine 114 may further obtain content from the social network source 112b (e.g., the Twitter™ network, etc.) in the region A, whereby the exposure engine 114 should be able to identify social network posts and/or comments related to an earthquake (e.g., directly, or by a threshold number of posts/comments related to the earthquake and/or having specific content relating thereto, etc.) in order for the earthquake event to be authenticated. In this example, the exposure engine 114 may require one hundred or more posts/comments from the social network source 112b related to the earthquake event in the last day, in order for the earthquake event to be authenticated.

With that said, it should be appreciated that the exposure engine 114 may authenticate only certain events (as described above), but not others. In so doing, the exposure engine 114 may identify the events to be authenticated based on the actions to be performed by the exposure engine 114 based thereon (e.g., certain events may require more extensive modifications relating to the payment network 106 as compared to other events, such that the certain events thereby require authentication; etc.).

Next in the method 300, once the event of interest is identified (and potentially authenticated), the exposure engine 114 compares, at 312, the event to known events/categories in the severity map stored in data structure 116. As shown above in Table 1, for example, several categories and events may be provided in the severity map for the payment network 106, against which the identified event of interest may be compared.

Then, based on a similar event in the severity map, the exposure engine 114 identifies the payment network 106 and/or the issuer 108 as associated with the region in which the event occurred and applies, at 314, the corresponding rule(s) from the severity map to the payment network 106 and/or issuer 108 in the region (e.g., in region A in this example, etc.). For example, in the above earthquake example, the severity map of Table 1 includes a rule to lower the fraud score threshold for transactions at merchants in region A within the MCC 5200 (home supply warehouse stores). In this manner, transactions at the merchants of this category become more readily authorized, for example, to facilitate recovery from the earthquake event.

In view of the above, the systems and methods herein may permit an exposure associated with a payment account transaction in a region, associated with and/or related to one or more events affecting the region, to be modified. In general, events may be understood, in the context of transaction data, to cause shifts in the types of transactions initiated, whereby the shifts may be good (e.g., additional transactions, etc.) or may be bad (e.g., increases in fraudulent activities, etc.). By understanding the shifts, based on historical data, and then identifying events as they occur, through different content sources (e.g., news feeds, social networks, etc.), the payment networks and/or issuers associated with the transactions may be modified, by application of one or more rules, to account for the likely shifts in the types of transactions, to promote good shifts while inhibiting and/or reducing bad shifts. Accordingly, the payment networks and/or issuers are modified (e.g., their operations for processing the transactions, etc.) in an unconventional manner to rely on data not previously considered, thereby improving the flexibility and/or operation of the payment networks and/or the issuers.

Again and as previously described, it should be appreciated that the functions described herein, in some embodiments, may be described in computer executable instructions stored on a computer-readable media, and executable by one or more processors. The computer-readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by one or more of: (a) obtaining, by a computing device, content from multiple data sources, the content including at least one event associated with a region, the at least one event not associated with a payment account transaction; (b) assigning, by the computing device, the at least one event to a category of events based on a type of the at least one event; (c) applying at least one rule to at least one operation of a payment network, for the region, based on a severity associated with exposure of the at least one event to the payment network, thereby modifying the exposure of the payment network in the region in connection with payment account transactions related to the at least one rule; (d) obtaining control content from the multiple data sources, the control content including a control event associated with the region; (e) assigning the control event to said at least one category of events based on a type of the control event; (f) obtaining transaction data for the region for an interval; (g) determining a severity of the control event based on the obtained transaction data; (h) storing the at least one rule in a data structure in association with the control event, prior to an occurrence of the at least one event; (i) determining an accuracy of the at least one event, based on the at least one event being included in content from more than one of the multiple data sources; and (j) determining the severity of the at least one event when the determined accuracy of the at least one event satisfies a threshold.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A network for use in adapting exposure in response to one or more events, the network comprising:
a memory including a data structure, the data structure including multiple predefined events and multiple actions, each of the predefined events associated with at least one of the multiple actions based on a severity of an exposure of the network to the predefined event; and
a processor coupled to the memory and in communication with at least one content source, the processor configured to:
obtain content from the at least one content source, via an application programming interface (API) associated with the at least one content source, the content including an event associated with a region;
associate the event to at least one of the multiple predefined events in the data structure; and
apply the at least one of the multiple actions associated with the at least one of the multiple events to the network, for at least one operation of the network in the region, thereby modifying the exposure of the network to the event in connection with subsequent network interactions in the region.

2. The network of claim 1, wherein the processor is further configured to:
determine a severity of an exposure of the network for the event based on the associated at least one of the multiple events; and
assign the at least one of the multiple actions to the event.

3. The network of claim 1, wherein the at least one content source includes multiple content sources; and
wherein the multiple content sources include one or more news sources and/or social network sources.

4. The network of claim 3, wherein the processor is further configured to identify the event associated with the region from the obtained content based on at least one keyword associated with the event.

5. The network of claim 1, wherein the network includes a payment network; and
wherein the at least one operation of the payment network includes application of at least one fraud prevention rule.

6. The network of claim 1, wherein the event associated with the region includes one of a political event and a natural calamity.

7. A computer-implemented method for use in adapting exposure of a payment network in a region based on one or more events affecting the region, the method comprising:
obtaining, by a computing device, content from multiple data sources, the content including at least one event associated with a region, the at least one event not associated with a payment account transaction;
assigning, by the computing device, the at least one event to a category of events based on a type of the at least one event; and
applying at least one rule to at least one operation of a payment network, for the region, based on a severity associated with exposure of the at least one event to the payment network, thereby modifying the exposure of the payment network in the region in connection with payment account transactions related to the at least one rule.

8. The computer-implemented method of claim 7, further comprising:
obtaining control content from the multiple data sources, the control content including a control event associated with the region;
assigning the control event to said at least one category of events based on a type of the control event;
obtaining transaction data for the region for an interval;
determining a severity of the control event based on the obtained transaction data; and
storing the at least one rule in a data structure in association with the control event, prior to an occurrence of the at least one event.

9. The computer-implemented method of claim 8, wherein the interval includes a control interval prior to the control event and an effect interval at least partially following the control event.

10. The computer-implemented method of claim 9, wherein obtaining content from multiple data sources includes searching, in the multiple data sources, for one or more keywords and retrieving content including the one or more keywords.

11. The computer-implemented method of claim 10, wherein the multiple data sources include one or more news sources and/or social networks sources; and
wherein searching, in the multiple data sources, includes calling an application programming interface (API) associated with at least one of the multiple data sources.

12. The computer-implemented method of claim 7, wherein the at least one event includes one of a political event and a natural calamity.

13. The computer implemented method of claim 7, further comprising determining an accuracy of the at least one event, based on the at least one event being included in content from more than one of the multiple data sources; and
determining the severity of the at least one event when the determined accuracy of the at least one event satisfies a threshold.

14. A non-transitory computer-readable storage media including executable instructions for use in adapting exposure of a payment network in a region based on one or more events affecting the region, which when executed by at least one processor, cause the at least one processor to:
obtain content from multiple data sources, the content including an event associated with a region, the event not associated with a payment account transaction processed by a payment network;
assigning the event to a category of events, based on a type of the event; and
applying a rule to an operation of the payment network, which is specific to the region, based on a severity associated with exposure of the event to the payment network, when the event is assigned to a category associated with the severity, thereby modifying an exposure of the payment network in the region associated with payment account transactions related to the rule.

15. The non-transitory computer-readable storage media of claim 14, wherein the executable instructions, when executed by the at least one processor, further cause the at least one processor to:
obtain control content from the multiple data sources, the control content including a control event associated with the region,
assign the control event to said category of events based on the a type of the control event;
obtain transaction data for the region for an interval;
determine a severity of the control event based on the obtained transaction;
assign the severity to said category of events; and
store the rule in a data structure associated with the processor prior to an occurrence of the event associated with the region.

16. The non-transitory computer-readable storage media of claim 15, wherein the executable instructions, when executed by the at least one processor, further cause the at least one processor to obtain the content and the control content from the multiple sources, via an application programming interface (API), associated with the multiple sources; and
wherein obtaining the content and/or the control content from the multiple sources is based on at least one keyword.

17. The non-transitory computer-readable storage media of claim 16, wherein the event includes one of a political event and a natural calamity.
